(19) United States
(12) Patent Application Publication
(10) Pub. No.: US 2020/0329639 A1
(43) Pub. Date: Oct. 22, 2020

(54) Rear to Center Frame Attachment Mechanism for a Zero-Turn Mower

(71) Applicant: Rabih Zoorob, Pueblo West, CO (US)

(72) Inventor: Rabih Zoorob, Pueblo West, CO (US)

(21) Appl. No.: 16/389,930

(22) Filed: Apr. 20, 2019

(51) Int. Cl. A01D 42/00; E02F 3/34; E02F 3/38

(52) U.S. Cl. CPC A01D 42/00; A01D 34/64; E02F 3/382; E02F 3/3417

(57) ABSTRACT

A zero-turn mower including a removably attached front-end loader, where front-end loader includes two boom arms and a bucket, and an attachment mechanism. The attachment mechanism may include a center plate, a loader attachment mechanism, and a mower attachment mechanism.

### REFERENCE TO PRIOR APPLICATIONS

This application claims the benefit of U.S. Provisional Application No. 62/632,558, filed Feb. 20, 2018.

### FIELD OF THE DISCLOSURE

The present invention relates generally to attachments to riding lawn mowers, and more particularly, to a front-end loader attachment for a zero-turn mower.

### BACKGROUND

Front-end loaders are typically heavy, and do not distribute their weight very evenly. Thus, front-end loaders, if they are attached to smaller vehicles, cause the smaller vehicles to tip over with or without an included payload. As a result, front-end loaders are only used with four-wheel-drive ATVs, tractors, or other larger vehicles that can support a front-end loader's weight and distribute that weight over four powered wheels. In other words, these vehicles have sufficient strength and balance to support a front-end loader with or without an include payload in the front-end loader's bucket.

However, there is a need to attach front-end loaders to smaller vehicles that are easier to operate, more maneuverable, and cost less Despite this need, currently, there is no mechanism to reliably attach a front-end loader to a smaller vehicle without making the vehicle difficult to operate, potentially dangerous, and prone to tipping over.

### BRIEF SUMMARY

A highly maneuverable vehicle including a front-end loader attachment, including a zero-turn mower, a front-end loader including two boom arms and a bucket, and an attachment mechanism. The attachment mechanism may include a center plate, a loader attachment mechanism, and a mower attachment mechanism.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is an illustrative embodiment of the invention attached to a zero-turn mower.

FIG. 1B is an illustrative embodiment of the invention attached to a zero-turn mower.

FIG. 2 is an illustrative embodiment of the invention attached to a zero-turn mower.

FIG. 3 is an illustrative embodiment of the attachment mechanism.

### DETAILED DESCRIPTION

The present invention described herein is for a zero-turn mower with a front-end loader attached to it. Moreover, the present invention described herein is also for an attachment mechanism for connecting a front-end loader to a zero-turn mower in a reliable manner that does not impair the maneuverability of the zero-turn mower, and does not cause the zero-turn mower to tip over.

The present invention solves the problems that are typically associated with attaching a front-end loader to a small, zero-turn vehicle, including, but not limited to reduced maneuverability, tip-over issues, increased risk/danger, etc. The attachment mechanism described herein solves these problems by distributing the weight of the front-end loader, with or without a payload in the front-end loader's bucket, across an appropriate length and width of the zero-turn mower, and reducing the center of gravity of the entire apparatus.

Moreover, the attachment mechanism does not interfere with the mowing mechanism on the zero-turn mower, and does not impair the mower's ability to mow. The inventive attachment mechanism also does not reduce the usable workspace and leg room that may be otherwise available on the top deck of a zero-turn mower. The attachment mechanism also enables the front-end loader to connect with the zero-turn mower's battery, thereby eliminating the need to include multiple batteries and maintain them.

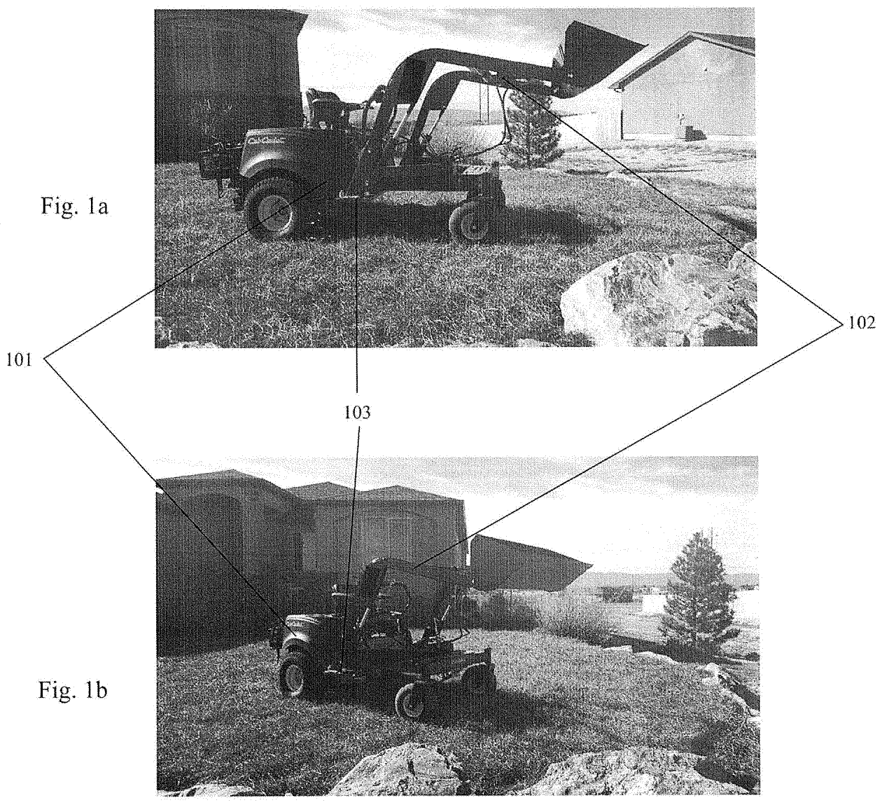

FIGS. 1A and 1B illustrate an exemplary zero-turn mower with a front-end loader attachment. The illustrations in FIGS. 1A and 1B are exemplary and for illustration purposes only; the inventive apparatus may be modified, as would be understood by a person of ordinary skill in the art, without departing from the scope of the invention. The inventive apparatus includes a zero-turn mower 101, a front-end loader 102, and an attachment mechanism 103, in accordance with one exemplary embodiment of the invention.

As illustrated in FIGS. 1A and 1B, a zero-turn mower 101 has the ability to make zero-degree turns. These types of vehicles typically include two powered back wheels and two front wheels that rotate three hundred and sixty degrees on a central hinge. The front wheels may be rotatable by a user, but no power is applied to the front wheels. This configuration allows the zero-turn mower to be extremely maneuverable and nimble.

For the purposes of this invention, any zero-turn mower, which may be known to a person of ordinary skill in the art, may be used without departing from the scope of the invention. Exemplary zero-turn mowers include CLUB CADET® mowers, IKON® mowers, JOHN DEERE® mowers, etc.

A front-end loader 102 is a device that is typically used to scoop material from the ground, such as dirt, sand, or gravel, and move it from one place to another without pushing the material across the ground. Typically, a front-end loader comprises two boom arms, a front mounted wide bucket, a cross brace, and a control mechanism. A variety of different types of loaders may be used herein without departing from the scope of the invention, including, but not limited to, front loaders, front-end loaders, skid-steer loaders, payloader, scoop loaders, shovel loaders, skip loaders, wheel loaders, etc. However, for ease of description, only a front-end loader is described and illustrated herein. Moreover, a variety of different buckets may be attached to the front-end loader, including a scoop, a bucket, a snow bucket (for picking-up or clearing snow/ice), a fork lift, etc., without departing from the scope of the invention.

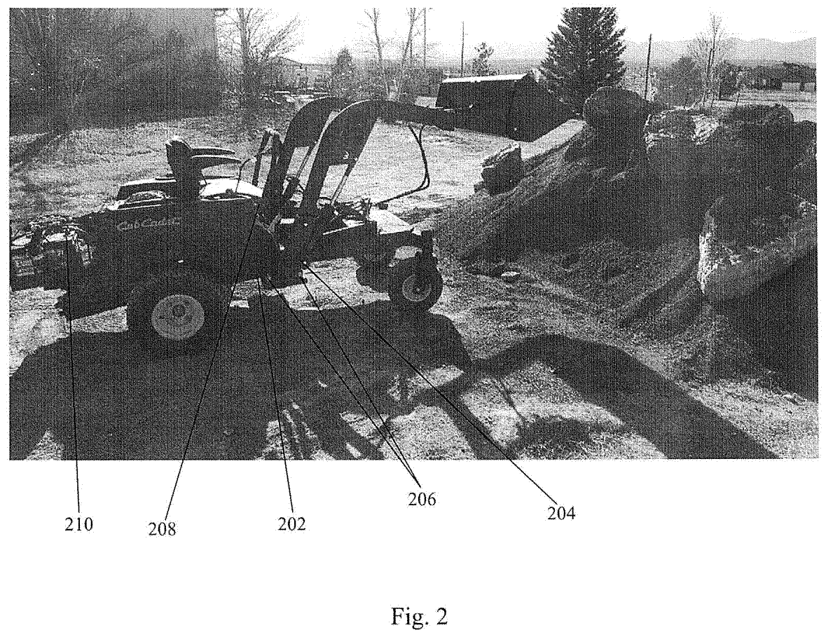

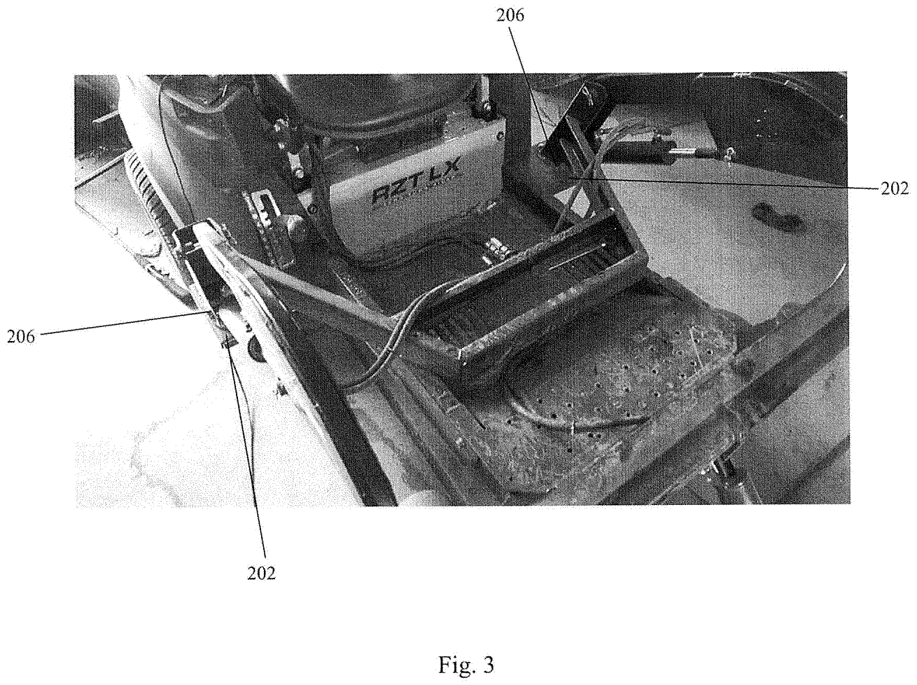

The attachment mechanism 103 attaches a front-end loader 102 to a zero-turn mower 101. The specific mechanisms for attaching a zero-turn mower 101 with a front-end loader 102 are described in greater detail below in reference to FIGS. 2 and 3.

FIGS. 2 and 3 illustrate the attachment mechanisms 103 for attaching the front-end loader 102 to a zero-turn mower 101. The attachment mechanism 103 includes a central plate 202, mower attachment points 204, loader attachment points 206, control installer 208, and a power source integrator 210. The attachment mechanisms 103, as illustrated in FIGS. 2 and 3 are exemplary. The invention described herein may include other embodiments, as consistent with this description, without departing from the scope of the invention.

The central plate 202, in one embodiment, extends across the width of a zero-turn mower's 101 central deck. In one embodiment, the central plate 202 is slightly longer than the width of the zero-turn mower's 101 deck to accommodate the loader attachment points 206, which are described in more detail below. In one embodiment, the central plate 202 sits below the zero-turn mower's 101 deck. However, central plate 202 may be installed above, or on top of the deck also. The central plate 202 is strong enough to support the weight of the front-end loader, a front load bucket, and a maximum payload that can be carried by the bucket and the hydraulic arm action of the front-end loader's boom arms. In one embodiment, the central plate 202 is angled so that it can be mounted on a variety of different mowers. Attaching the central plate 202 underneath the mower deck is the preferred embodiment because it lowers the center of gravity of the entire apparatus and uses the mower deck and frame as a counter weight to force applied by the front-end loader 102.

Mower attachment points 204 secure the central plate 202 to the zero-turn mower 101. In one embodiment, the mower attachment points 204 may include a screw and bolt configuration. However, other configurations may be used, as would be readily apparent to a person of ordinary skill in the art, without departing from the scope of the invention, including, for example, welding the two components together, ballast joints, hook and loop systems, reinforced connectors, etc. The mower attachment points 204, however, must be small enough to not interfere with connecting the mower attachment at the bottom of the zero-turn mower.

The loader attachment points 206 secure the front-end loader to the central plate 202. In one embodiment, the loader attachment points 206 are included on both ends of the central plate 202. The loader attachment points 206 connect to the front-end loader's 102 boom arms and cross brace. The loader attachment points 206 and the loader attachment mechanisms must be strong enough to support the weight of the front-end loader with a bucket that is filled with maximum payload. In one embodiment, the loader attachment points comprise a hole for a screw, or a nut and bolt attachment mechanism. However, as would be readily understood to a person of ordinary skill in the art, other attachment mechanisms may be used without departing from the scope of the invention, including, for example, welded joints, hook and loop closure systems, ballast joints, reinforced connectors, etc.

In one embodiment, the loader attachment points 206 connect to the front-end loader's 102 boom arms specifically. In such an embodiment, a front-end loader's 102 cross brace, if available, is not necessary and may be removably decoupled from the front-end loader 102. This configuration may be easier to install, and allows for additional room on the top deck of the zero-turn mower 101.

In one embodiment, the loader attachment points 206 connect to the front-end loader's 102 boom arms as well as the front-end loader's 102 cross brace. In yet another embodiment, the loader attachment points 206 connect to the front-end loader's 102 boom arms, but the front-end loader's cross brace may be bolted directly onto the zero-turn mower's deck.

The control installer 208 enables the attachment mechanism to make the front-end loader's 102 control system easily accessible to a user who is sitting on the zero-turn mower 101. FIG. 2 illustrates one exemplary location of the control installer 208 in accordance with the scope of the invention. However, other locations may be used without departing from the scope of the invention.

The power source integrator 210 connects the front-end loader 102 to the power system of the zero-turn mower. This configuration permits the zero-turn mower 101 and the front-end loader 102 to operate out of the same power source, which reduces the weight of the apparatus, but also makes it easier to manage, store, and service the inventive apparatus. The specific configuration of the power source integrator 210 may vary based on the type of power source, and the size of the power source. In one embodiment, the power source is a battery. The battery's power output may be split to supply the zero-turn mower 101, and the front-end loader 102. Other mechanisms for integrating the power sources may be used without departing from the scope of the invention.

Another feature of the inventive apparatus described herein is that the front-end loader 102 may be coupled and decoupled from the zero-turn mower for easy storage and usage. In one embodiment, the attachment mechanism allows for easy connection and removal, thereby enabling a user to store the front-end loader in a garage or a shed when not in use.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A highly maneuverable vehicle including a front-end loader attachment, comprising:
a zero-turn mower;
a front-end loader including two boom arms and a bucket;
an attachment mechanism comprising a center plate, a loader attachment mechanism, and a mower attachment mechanism.
